(19) United States
(12) Patent Application Publication
(10) Pub. No.: US 2018/0006483 A1
(43) Pub. Date: Jan. 4, 2018

(54) Wireless Charging Devicce

(71) Applicant: Bryan Carr, Toney, AL (US)

(72) Inventor: Bryan Carr, Toney, AL (US)

(21) Appl. No.: 15/199,425

(22) Filed: Jun. 30, 2016

(51) Int. Cl. H02J 7/02; H02J 7/00; H04B 1/3827; H04W 84/12

(52) U.S. Cl. CPC H02J 7/025; H04W 84/12; H02J 7/0042; H04B 1/3833

(57) ABSTRACT

A wireless charging device for use in charging batteries of electronic device such as a mobile phone, multimedia play devices etc. The wireless charging device includes a transmitter for transmitting signals in the range of Bluetooth® and Wi-Fi and an adaptor for receiving the signals transmitted by the transmitter and converting the signals into electrical signals for charging the battery. The adaptor could be removably plugged into the charging port of electronic devices or the adaptor could be built into the electronic device

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to charging devices and more specifically to charging devices that provide charging via wireless connections.

### BACKGROUND

The use of portable electronic devices has increased exponentially, in particular the use of mobile phones, audio/video players etc. The portable electronic devices generally use rechargeable batteries as a source of power and the batteries have to recharge frequently depending upon the capacity of battery and consumption by the electronic device. In addition, it is known that larger the size of battery, longer it could provide power and thus lesser recharging. However, there are aesthetic limitations to increase the battery sizes as larger size of battery will increase the size of electronic device. Thus, significant amount of money is invested in developing improved batteries and charging devices.

### SUMMARY

The present disclosure relates to a wireless charging device for electronic devices. In an embodiment, the wireless charging device of the present disclosure charges rechargeable batteries of electronic device up to predetermined distance. In an embodiment, wireless charging device of the present disclosure automatically charges batteries without intervention of the user. In an embodiment, the wireless charging device of the present disclosure is safe to use.

Certain embodiments of the present invention provide a wireless charging device for use in charging batteries of electronic devices, such as a mobile phone, multimedia players etc. In an embodiment, the wireless charging device comprises a transmitter for transmitting signals using a wireless technology.

In an embodiment, the wireless technology utilizes short-wavelength UHF radio waves. In an embodiment, the short-wavelength UHF radio waves are in the ISM band from 2.4 to 2.485 GHz (e.g. Bluetooth®). the wireless technology is Wi-Fi (for example, 2.4 gigahertz (12 cm) UHF and 5 gigahertz (6 cm) SHF ISM radio bands.)

In an embodiment, the wireless charging device additionally comprises an adaptor for receiving the signals transmitted by the transmitter and converting the signals into electrical signals for charging the battery. In another embodiment, the adaptor could be removably plugged into the charging port of electronic devices. In another embodiment, the adaptor is built into the electronic device. In another embodiment, the electronic device or the adaptor could detect the charger and starts receiving signals from the transmitter.

In addition to the various objects and advantages of the present invention described with some degree of specificity above it should be obvious that additional objects and advantages of the present invention will become more readily apparent to those persons who are skilled in the relevant art from the following more detailed description of the invention.

### BRIEF DESCRIPTION OF THE DRAWINGS

The embodiments are illustrated by way of example and not limitation in the figures of the accompanying drawings in which like references indicate similar elements.

FIG. 1 illustrates one exemplary embodiment of the wireless charging device according to present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

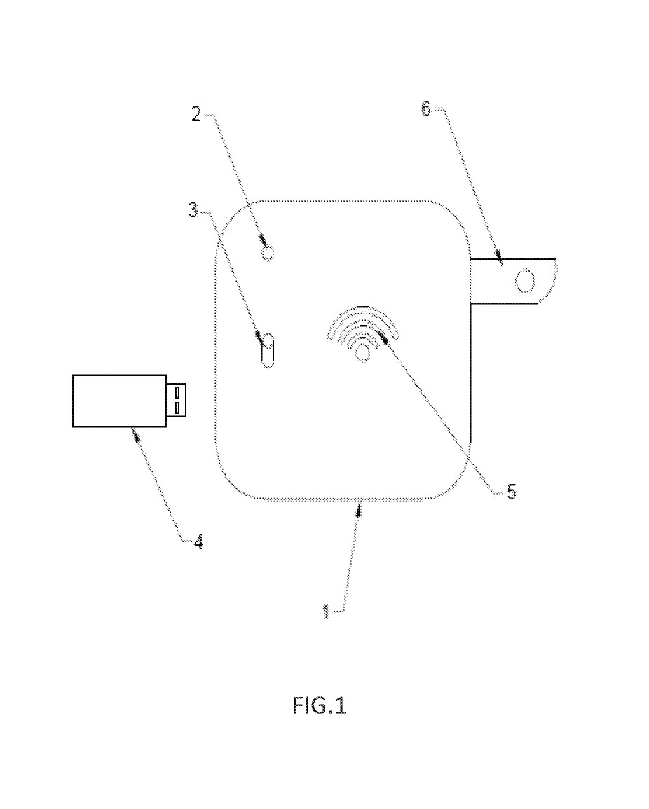

Looking to FIG. 1, there is illustrated an exemplary embodiment of the wireless charging device 1 of the present disclosure. The device illustrated in the figure is a square shaped housing having a light indicator 2, which shows the status of the device (i.e. the weather the charging device is on or off.) The light can be a LED of any suitable color, such as red, green, blue etc. and more than one light can be used for example red and green led could be used to show the operating status of the device.

A power switch 3 for turning the device on or off is also provided and can be provided anywhere in the device and protruding outwards from the housing. For example, the figure illustrates a push button on sidewall of the housing. The illustrated device further shows a USB connector 4 that can be used with automobile electrical system. Generally, the automobile have a USB port for powering electronic devices, the same port could be used to power the charging device of present invention and the device further provide wireless charging for other electronic devices in or nearby the automobile.

In an embodiment, the device further includes a radio button 5 that turns the transmitter inside the housing on and off. Furthermore, electrical prongs 6 are provided for connecting the device to the electrical socket.

The housing of wireless charging device includes a transmitter for transmitting the signals in range of Wi-Fi (for example, 2.4 gigahertz (12 cm) UHF and 5 gigahertz (6 cm) SHF ISM radio bands.) and Bluetooth® (short-wavelength UHF radio waves in the ISM band from 2.4 to 2.485 GHz. The radio button 5 provided in the device allows turning the transmitter on and off.

In an embodiment, an adaptor, which can receive the signals transmitted by the adaptor, connects to the electronic device, for example an external adaptor could be provided which could connect to the charging port of the electronic device, or the adaptor could be built into the electronic device. The adaptor works by converting the signals transmitted by the transmitter, which are in range of Bluetooth® and Wi-Fi to electrical signals, which then charge the battery of the electronic device. The strength of the signals transmitted decreases with the distance covered by the signals, and the charging device could charge any electronic devices within, for example, 30 feet of area.

In an embodiment, when the electronic device is a mobile phone, the wireless charging device has a device id, which could be recognized by the mobile device by searching the available wireless networks, for example, Wi-Fi or Bluetooth® networks. Once the device is added to the mobile device or a communication is established between the mobile device and the wireless charging device, the adaptor could start receiving the signals from the transmitter.

In an embodiment, the mobile device allows automatic searching of Wi-Fi networks, and thus the mobile phone could automatically search for nearby charging device within range and starts charging the mobile phone without any intervention of the user. Thus, the user does not have to worry anymore about recharging the mobile phone. In an embodiment, public charging stations could be provided wherein the mobile device could automatically recognize such charging system and starts charging the mobile phone. For other electronic devices suitable mechanism like beacon signal can be provided for wirelessly connecting the adaptor to the transmitter.

In various embodiments, the transmitter provide signals, so any device could be easily charged without worrying about the voltage, type of particular charger suitable for electronic device, thus providing a type of universal charger for electronic devices. Moreover, the wireless charging device according to present disclosure could be used to charge multiple electronic devices simultaneously. For example, in a general household, the wireless charging device could be used to charge all the mobile phones, electronic device like laptops, televisions. and portable multimedia players, removing the need of electrical wires.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A wireless charging device comprising:
a transmitter configured to wirelessly transmit signals utilizing a wireless technology;
an adaptor operably coupled to an electronic device and configured to receive the signals from the transmitter and converting the signals to electrical signals for charging a rechargeable battery of the electronic device.

2. The wireless charging device of claim 1, wherein the wireless technology is Wi-Fi.

3. The wireless charging device of claim 1, wherein the wireless technology utilizes short-wavelength UHF radio waves.

4. The wireless charging device of claim 3, wherein the short-wavelength UHF radio waves are in an ISM band from 2.4 to 2.485 GHz.

5. The wireless charging device of claim 1, wherein the electronic device is one of: a mobile phone and a portable multimedia player.

6. The wireless charging device of claim 1, wherein the adaptor is adapted for removably connecting to a charging port of the electronic device.

7. The wireless charging device of claim 1, wherein the adaptor is built into the electronic device.

8. The wireless charging device of claim 1, wherein the electronic device is configured to detect the wireless charging device over a wireless network and establish a wireless communication with the wireless charging device.

9. A method of charging a mobile phone wirelessly comprising steps of:
providing a wireless charging device, the wireless charging device comprising a transmitter configured to transmit signals utilizing a wireless technology;
providing an adaptor for receiving the signals from the transmitter and converting the signals into an electrical signals;
operably coupling the adaptor to the mobile phone;
detecting the wireless charging device from the mobile phone over a wireless network;
establishing a wireless communication between the mobile phone and the wireless charging device.

10. The method of claim 9, wherein the wireless technology is Wi-Fi.

11. The method of claim 9, wherein the wireless technology utilizes short-wavelength UHF radio waves.

12. The method of claim 11, wherein the short-wavelength UHF radio waves are in an ISM band from 2.4 to 2.485 GHz.
